(19) United States
(12) Patent Application Publication
(10) Pub. No.: US 2015/0279221 A1
(43) Pub. Date: Oct. 1, 2015

(54) METHOD FOR HANDLING ASSIGNMENT OF PEER-REVIEW REQUESTS IN A MOOCS SYSTEM BASED ON CUMULATIVE STUDENT COURSEWORK DATA PROCESSING

(71) Applicant: KONICA MINOLTA LABORATORY U.S.A., INC., San Mateo, CA (US)

(72) Inventor: Daniel Barber, San Francisco, CA (US)

(73) Assignee: KONICA MINOLTA LABORATORY U.S.A., INC., San Mateo, CA (US)

(21) Appl. No.: 14/226,730

(22) Filed: Mar. 26, 2014

(51) Int. Cl. G09B 5/00

(52) U.S. Cl. CPC G09B 5/00

(57) ABSTRACT

A method implemented in a MOOCs (Massive Open Online Courses) system for handling requests for peer-review of student's homework assignments. When a peer-review request is received, the system first selects as candidate reviewers a number of students who are about to become active on the MOOCs system, then calculates a peer-review matching score for each candidate reviewer. The score is based on language, academic ability on the subject of the homework, peer-review history, etc. of the students. The peer-review request is assigned to a relatively small number of candidate reviewers with top matching scores. After a number of completed reviews (grades) are received, the system determines whether a sufficient number of completed reviews having grades within one standard deviation are received. If so, a final grade is calculated from the grades within one standard deviation; and if not, the assignment process is repeated. This method promotes efficient and effective peer-review.

### BACKGROUND OF THE INVENTION

1. Field of the Invention

This invention relates to a MOOCs system for online education, and in particular, it relates to methods of facilitating peer-review of homework by students taking MOOCs courses.

2. Description of Related Art

MOOCs, or Massive Open Online Courses, are online educational institutions that serve millions of students worldwide. A MOOCs system provides online education by having students read, view or interact with educational materials online, as well as take tests online. By their very nature, MOOCs have thousands of students enrolled, but typically only a fraction of the students finish. One of the main reasons identified by students that they do not complete the courses is that they are unable to get the help they need when they find the course content difficult. Current MOOCs systems use web forums as a predominant way to address student's questions. Students (users) can post questions or requests for help on the forum, and other students (users) may voluntarily answer any of the posted questions. This system tends to be inefficient and hard to use, and often leads to student's questions going unanswered. It is also difficult for students to receive peer-review of their work.

### SUMMARY

The present invention is directed to a method implemented in a MOOCs system for handling peer-review of students' homework assignments to accomplish the goal of having homework assignments reviewed by competent peers in a timely manner.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides a method implemented in a MOOCs (Massive Open Online Courses) system for handling peer-review of homework assignments, the MOOCs system including one or more server computers providing web-based educational materials, the method being implemented on the server computers, which includes: (a) storing, in a database, information about each of a plurality of students registered with the MOOCs system, including their academic abilities in each of a plurality of subjects of study; (b) receiving a peer-review request for reviewing a homework assignment from a requesting student; (c) selecting as candidate reviewers a group of the plurality of students who are active on the MOOCs system or are predicted to become active within a predetermined time period from a current time; (d) for each of the candidate reviewers selected in step (c), calculate a peer-review matching score with respect to the homework assignment using the stored academic abilities information of the students; (e) assigning the peer-review request to a first predetermined number of candidate reviewers who have the highest peer-review matching score among the candidate reviewers; and (f) upon receiving a second predetermined number of completed reviews from at least some of the reviewers assigned in step (e), each completed review including a grade value for the homework assignment, calculating an average and a standard deviation of the grade values of all completed reviews received up to that time; (g1) if fewer than a third predetermined number of completed reviews have acceptable grade values based on the calculated standard deviation, repeating steps (c) to (f); and (g2) if more than or equal to the third predetermined number of completed reviews have acceptable grade values, calculating a final grade for the homework assignment using the completed reviews that have acceptable grade values, and transmitting the final score to the requesting student.

In another aspect, the present invention provides a method implemented in a MOOCs (Massive Open Online Courses) system for handling peer-review of homework assignments, the MOOCs system including one or more server computers providing web-based educational materials, the method being implemented on the server computers, which includes: (a) storing, in a database, information about each of a plurality of students registered with the MOOCs system, including their academic abilities in each of a plurality of subjects of study and their online access histories; (b) receiving a peer-review request for reviewing a homework assignment from a requesting student; (c) based on the stored online access history information of the students, selecting as candidate reviewers a group of the plurality of students who are predicted to become active on the MOOCs system within a predetermined time period from a current time; (d) for each of the candidate reviewers selected in step (c), calculate a peer-review matching score with respect to the homework assignment using the stored academic abilities information of the students; (e) assigning the peer-review request to a first predetermined number of candidate reviewers who have the highest peer-review matching score among the candidate reviewers; and (f) calculating a final grade for the homework assignment based on completed reviews received from at least some of the assigned reviewers, and transmitting the final score to the requesting student.

In another aspect, the present invention provides a computer program product comprising a computer usable non-transitory medium (e.g. memory or storage device) having a computer readable program code embedded therein for controlling a data processing apparatus, the computer readable program code configured to cause the data processing apparatus to execute the above method.

It is to be understood that both the foregoing general description and the following detailed description are exemplary and explanatory and are intended to provide further explanation of the invention as claimed.

### BRIEF DESCRIPTION OF THE DRAWINGS

FIG. 1 schematically illustrates a peer-review handling method implemented in a MOOCs system.

FIG. 2 schematically illustrates a method for calculating academic scores reflecting academic abilities of students according to the embodiment of the present invention.

FIG. 3 illustrates exemplary academic scores for a number of students.

FIG. 4 schematically illustrates a MOOCs system in which embodiments of the present invention may be implemented.

### DETAILED DESCRIPTION OF PREFERRED EMBODIMENTS

Embodiments of the present invention provide a method implemented in a MOOCs system to facilitate peer-review of student's homework assignments. When a student taking a MOOCs course requests peer-review of a homework assignment she has completed, the system uses a matching algorithm to match the peer-review requests to reviewers (other students of the MOOCs system) in a way that achieves a twofold goal: First, to have the homework peer-reviewed by a competent peer; second, to have the homework peer-reviewed as fast as possible.

To enable the matching algorithm, information about individual students registered with the MOOCs system, including their academic abilities in various subjects of study, their peer-review histories, their online access histories, etc., is gathered, stored in a database and analyzed to determine how peer-review requests will be assigned. Peer-review history of a student refers to how often a student peer-reviews other students' homework assignments, e.g., at least once a day, approximately once a week, rarely, etc. Online access history (habit) of a student refers to the time of the day and/or week during which the student typically accesses the MOOCs system. The gathering and processing of student information is described in more detail later.

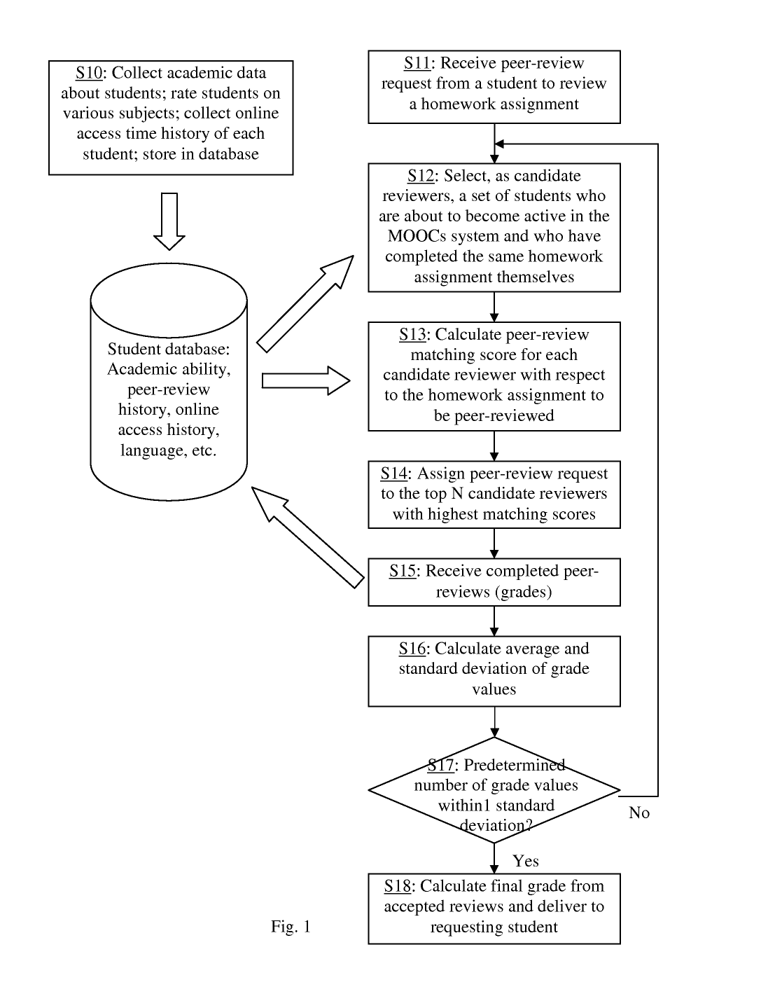

Using the gathered and analyzed data about the students, a peer-review assignment method according to embodiments of the present invention can assigns peer-review requests in an effective and intelligent manner, as described below with reference to FIG. 1.

When the MOOCs system receives a request from a student (the requesting student) to review a homework assignment she has completed (step S11), the system first selects a set of students who are about to become active (e.g. about to log on) in the MOOCs system (step S12). This selection is based on the student online access history (habit) data stored in the database. As mentioned earlier, the online access history (habit) of a student refers to the time of the day and/or week during which she typically accesses (e.g. logs on to) the MOOCs system. Students of a MOOCs system often access the MOOCs system to study during relatively regular hours of the day and week. Thus, using the access history data, at any given time, the likelihood that a particular student is about to become active in the system can be calculated. Step S12 may select, as candidate reviewers, students who have a high likelihood of becoming active in the MOOCs system within a predetermined time period (e.g., 10 minutes) from the current time. Here, “active” may mean logging onto the MOOCs system, and/or starting a period of active participation of study activities. The time matching is done using the candidate reviewer's local time.

By using such a selection method, it can be ensured that the peer-review requests will be assigned to peers who are most likely to see the request in a timely manner. If peer-review requests are sent to students who are currently active, there is a risk that they may be about to log off or become inactive, and therefore may not be able or willing to respond to the request during the current logon session. This problem is more common in a MOOCs system where a typical logon or active time duration is relatively short, as compared to, for example, the scenario of a company's online customer service system which is staffed by designated personnel on a regular basis. Assigning peer-review requests to students who are about to become active has the advantage of avoiding the above problem and ensuring that the assigned students will have the request for the duration of their online time.

Preferably, step S12 limits the selected candidate reviewers to those students who have themselves completed the same homework assignment, but this is not mandatory. Step S12 preferably selects all students of the MOOCs system who meet the above requirements. Alternatively, if the MOOCs system has a very large number of students, a subset (e.g., a random subset) of students meeting the above requirements may be initially selected in step S12.

Then, a peer-review matching score is calculated for each candidate reviewer with respect to the homework assignment to be reviewed (step S13). The matching score is calculated by taking into account a number of factors, including: the language of the requesting student and the candidate reviewer, the academic ability of the candidate reviewer in the subject of the homework assignment, the peer-review history of the candidate reviewer, etc. The subject of the homework assignment is preferably a parameter pre-associated with the homework, e.g. by the person who designed the homework, or it may be designated by the requesting student.

Generally, the score will be higher if the candidate reviewer speaks the same language as the requesting student, has high academic ability in the subject, and in the past peer-reviewed assignments in this subject at a relatively high rate.

In one particular implementation, the matching score starts from a base start point (e.g. 0.5); it is decreased by a value (e.g. 0.3) if the candidate reviewer does not speak the same language as the requesting student; adjusted by an appropriate value (e.g. from 0.2 to −0.2) depending on the academic ability of the candidate reviewer (e.g., rated at five levels from expert to poor); and increased by 0.1 if the candidate reviewer peer reviews questions in this subject at a rate of more than 1 per day, etc. Of course, other formulas can be used to calculate the peer-review matching score.

In one particular example, the algorithm for calculating the peer-review matching score may be expressed in the following formula (Eq. (A)):

ΣC_{base}(φ_{lang}→M₁)+(φ_{SRate1}→M₄)⊕(φ_{SRate2}→M₅)+(φ_{SRate3}→M₆)⊕(φ_{SRate4}→M₇)+(φ_{Acnt}→M₈)

The notations used in this formula are as follows: each φ represents an event or condition; each M represents a value; and the notation “φ→M” means that if the condition φ is true then the value M is assigned. The notation “⊕” means “or”. The meanings of the various parameters and values in Eq. (A) are as below:

C_{base}=base start point

φ_{lang}=Users language is the same as the requesting user

φ_{SRate1}=User is considered good at the topic

φ_{SRate2}=User is considered bad at the topic

φ_{SRate3}=User is considered an expert at the topic φ_{SRate4}=User is considered poor at the topic

φ_{Acnt}=User answers peer reviews at a rate of more than 1 per day

M₁=language match modifier

M₄=Good user Rating Modifier

M₅=Bad user Rating Modifier

M₆=Expert user Rating Modifier

M₇=Poor user Rating Modifier

M₈=Peer Review Rate Modifier

Based on the peer-review matching score, a number of (e.g. top 10) candidate reviewers having the highest peer-review matching scores are selected as reviewers and the peer-review request is assigned to each of them (step S14). The assignment of peer-review requests may be implemented by sending messages to the reviewers using a messaging system implemented within the MOOCs system.

Some of the reviewers will choose to review the homework and return the completed review, including a grade value. After a number of (e.g. 3) completed reviews are received (step S15) and/or after a predetermined time period expires, the MOOCs system calculates an average grade value and a standard deviation using all of the received grade values (step S16).

At this time, if the number of grade values that are within one standard deviation is below a predetermined number (e.g. 10) (“No” in step S17), the system repeats steps S12 to S14 to assign the peer-review request to an additional number of reviewers. Of course, the one standard deviation is only one criterion of determining what reviews should be accepted; other criteria may be used as well.

It should be noted that, because step S12 is repeated at a new time point, a different set of candidate reviewers will be selected which will include students who are about to become active within a certain time period from the new time point. Thus, the candidate reviewers selected in the repeated step S12 will tend to be different from those selected in the previous round. In the event some previously selected reviewers are still included in the set of candidate reviewers when step S12 is repeated, they are removed from the new selection.

Then, after additional number of completed reviews are received (step S15) and/or after a predetermined time period expires, the cumulative average and standard deviation of all received grade values are recomputed (step S16). This process is repeated until a predetermined number of acceptable reviews (within 1 standard deviation) are received (“Yes” in step S17).

The final average grade for the homework assignment is calculated from the acceptable reviews, and the review result, including the final grade and any comments, is delivered to the requesting student (step S18).

In the method described above, the peer-review assignment process (S12 to S16) is repeated multiple rounds; in each round a relatively small number of students are assigned the peer-review request, until a satisfactory number of acceptable reviews results are received. An advantage of this method is that it avoids unnecessarily sending the request to too many students. For example, an alternative method of reaching the goal of a predetermined number of completed reviews within one standard deviation would be to initially send out a much larger number of peer-review requests, so that a sufficient number of completed reviews will be received and a sufficient number of them will be within one standard deviation. Such an alternative method is much more likely to result in an excess number of reviews being done unnecessarily. Unnecessary reviews will increase the work load of students, especially those who are competent and willing to provide peer-reviews. Also, too many peer-review requests received by a student may cause some requests to go un-responded to. Thus, by using the iterative method of the present embodiment, the total number of peer-review requests sent to students can be reduced, and the reviewers are more likely to complete the reviews in a timely and quality manner.

During the above process, the MOOCs system may also update the student's peer-review history in the student database after receiving completed reviews from peer-reviewers in step S15.

As mentioned earlier, one of the factors used to calculate the peer-review matching score for assigning peer-review requests (step S13) is each student's academic abilities in various subjects of study. Here, “subjects” may be defined at any suitable levels, such as biology vs. history, different areas of biology or history, or different sections or topics within a course, etc. Subjects may be identified based on the syllabus; for example, each course, or each section within each course, may be identified as a subject.

The academic abilities of each student are obtained by collecting and analyzing a large and detailed dataset from the MOOCs system (step S10 of FIG. 1). Some examples of the academic information to be collected and analyzed include:

Test related data: The MOOCs system provides various online (automated) tests for each course or each section of a course, and students are scored on these tests. Test related data of each student are collected, including test scores, time to completion (how long it takes the student to complete a test), the number of times each test is retaken by the student (a MOOCs often allows each student to take a test multiple times e.g. to improve their scores), results of individual question within a test, etc. There are typically different types of tests, including more informal ones (often referred to as quizzes) and more formal ones. Quizzes are typically given more frequently, and tests are typically given less frequently, such as once or twice for each course.

Homework related data: The MOOCs system require students to complete homework assignments which are then graded. Each student's grade for homework assignments and individual question results within each homework assignment (if available) are collected.

Page work related data: MOOCs students study their subjects by reading, viewing or practicing study materials online. The study materials may be text, images, video, interactive web pages, etc. The time a student spends on a unit of materials is collected. For example, a section or chapter of the study material may be presented as a web page, and the time a student spends on the web page may be collected, to the largest extent possible. For convenience, this data is referred to as page work related data here.

Data about postings on the forum: As mentioned before, MOOCs have forums for their students to use to ask questions and get help. The forum is preferably moderated (e.g. abusive postings may be removed), topic sorted, and question driven. On such a forum, users' answers can be rated by the moderator, by the asker or by other users as to whether they are correct or helpful. Here, data about questions each student asks on the forums, questions each student successfully or correctly answers for other students, and what topics the questions relate to, are collected.

The timestamp of all the above student events for each event may be collected as well.

In addition, information about the geographical location (e.g., latitude/longitude, physical address, country, city, IP address, etc.) and locale (the user computer's locale settings, such as keyboard layout, language, time zone, etc.) of each student may be collected. Such information may be obtained from the students during a registration process, and/or from the IP addresses of the computers they use to access the MOOCs system, etc.

The above data is collected on each individual student. The students are identified by the user IDs.

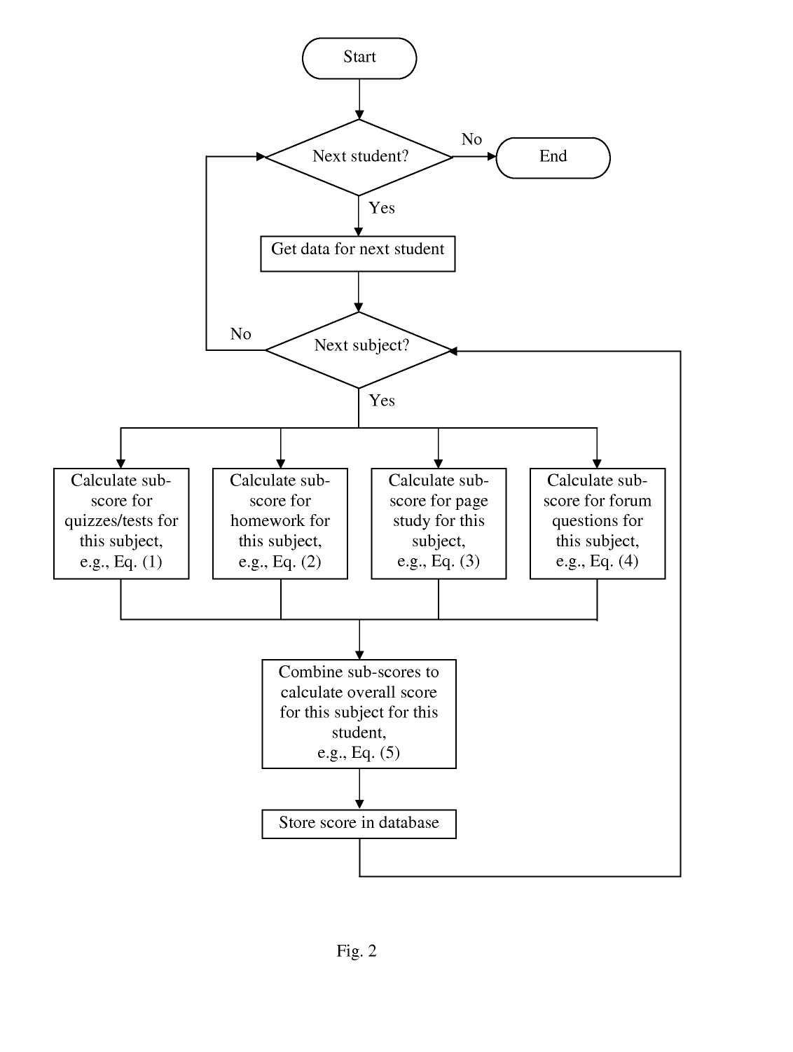

The data about individual student is processed to calculate a score of each student on each subject of study, as described below with reference to FIG. 2. For each student and each subject (e.g. subject A), first, test related data is used to calculate a first sub-score. Generally, this sub-score will be higher if the student passed the test on first try, got all questions correct on first try, completed the tests in a relatively short amount of time, and/or scored high in the test, etc.; and lower if the student completed the test in a relatively long amount of time, did not pass the test, got no questions correct, retook the test and failed again, and/or scored low in the test, etc. The results from all tests taken by the student on the subject are accumulated.

In one particular example, for each test, starting from a base score of 0.5, the sub-score is increased or decreased as follows:
Passed on first try: +0.2
Got all questions correct on first try +0.3
Completed quiz/test outside of 1 standard deviation of time compared to other students (+0.1 or −0.1 for faster or slower, respectively)
Didn't Pass: −0.2
Got no questions correct −0.3
Retook quiz/test and failed again: −0.1
Score modifier: if student's score is 1 standard deviation or more from the average, add or subtract 0.1 from the score for higher or lower, respectively.

Using these exemplary values, for each test, an expert on the topic may get a score of 1 and a novice with no experience at all on the topic may get a score of 0.

In one particular example, the algorithm for calculating this sub-score is expressed by the following formula (Eq. (1)):

$${C}_{1} = \sum [ {C}_{base} + ( {ϕ}_{isQuiz} -> {M}_{0} ⊕ {ϕ}_{isTest} -> {M}_{1} ) ( ( {ϕ}_{First} -> {M}_{2} ) + ( {ϕ}_{Perfect} -> {M}_{3} ) + ( ( {ϕ}_{time} > λ + {σ}_{time} -> {M}_{4} ) ⊕ ( {ϕ}_{time} < λ - {σ}_{time} -> {M}_{5} ) ) + ( {ϕ}_{Failed} -> {M}_{6} ) + ( {ϕ}_{None} -> {M}_{7} ) + ( {ϕ}_{retook} -> {M}_{8} ) + ( ( {ϕ}_{Score} > μ + {σ}_{Score} -> {M}_{9} ) ⊕ ( {ϕ}_{Score} < μ - {σ}_{Score} -> {M}_{10} ) ) ) ]$$

The notations used in this formula are as follows: each φ represents an event or condition; each M represents a value; and the notation “φ→M” means that if the condition φ is true then the value M is assigned. The notation “⊕” means “or”. The sum is over all tests on the subject A taken by the student. The meanings of the various parameters and values in Eq. (1) are as below:

C_{base}=Base start point

φ_{isQuiz}=If the task is a quiz

φ_{isTest}=If the task is a test

φ_{First}=If the user passed on the first try

φ_{Perfect}=If the user received a perfect score

φₜᵢₘₑ=The time taken by the user to complete the task

φ_{Failed}=If the user failed the task

φ_{None}=If the user got 0 questions correct

φᵣₑₜₒₒₖ=If the user retook the task and failed again

φ_{Score}=The user's score

M₀=Quiz Modifier

M₁=Test Modifier

M₂=First Try Modifier

M₃=Perfect Score Modifier

M₄=Time Modifier positive

M₅=Time Modifier negative

M₆=Fail Modifier

M₇=0% Modifier

M₈=Retake Modifier

M₉=Score Modifier positive

M₁₀=Score Modifier negative

λ=Mean or Average Time to Complete task for all students

μ=Mean or Average Score for task for all students

σₜᵢₘₑ=1 Standard Deviation of Time for task completion

σ_{Score}=1 Standard Deviation of Score for task

As expressed in this formula, for each test, the formula calculates a score by starting from a base score Cₕₐₛₑ which is then modified by various modifier values M based on various events or conditions φ relating to tests. For example, if the student passes the test on the first try, the score is modified by M₂ (σ_{First}→M₂). Each term is weighted by a weighting factor M₀ or M₁ depending on whether the task is a more informal one (a quiz) or a more formal one (a test) (φ_{isQuiz}→M₀⊕φ_{isTest}→M₁). Of course, other types of testing may be designated and given their weights; or, different types of testing may be given the same weight. In one particular example, each quiz is given a weight of M₀=0.5, and each test is given a weight of M₁=1. The values given to the various modifiers M in Eq. (1) correspond to the nature of the corresponding conditions or events; some examples are given above.

Second, homework related data is used to calculate a second sub-score. Generally, this sub-score will be higher if the student completed the homework on first try, completed the homework correctly on first try, completed the homework in a relatively short amount of time, and/or received a high grade in the homework, etc.; and lower if the student completed the homework in a relatively long amount of time, did not complete the homework, did the homework incorrect, re-did the homework and failed to complete it again, and/or received a low grade in the homework, etc. The results from all homework assignments on the subject are accumulated.

In one particular example, for each homework assignment, starting from a base score of 0.5, the sub-score is increased or decreased as follows:
Completed on first try: +0.2
Got the entire homework correct on first try +0.3
Completed homework outside of 1 standard deviation of time compared to other students (+0.1 or −0.1 for faster or slower, respectively)
Didn't complete: −0.2
Got no part of the homework correct −0.3
Score modifier: if student's score is 1 standard deviation or more from the average, add or subtract 0.1 from the score for higher or lower, respectively

Using these exemplary values, for each homework assignment, an expert on the topic may get a score of 1 and a novice with no experience at all on the topic may get a score of 0.

In one particular example, the algorithm for calculating this sub-score is expressed by the following formula (Eq. (2)):

$${C}_{2} = \sum [ {C}_{base} + ( {ϕ}_{First} -> {M}_{2} ) + ( {ϕ}_{Perfect} -> {M}_{3} ) + ( ( {ϕ}_{time} > λ + {σ}_{time} -> {M}_{4} ) ⊕ ( {ϕ}_{time} < λ - {σ}_{time} -> {M}_{5} ) ) + ( {ϕ}_{Failed} -> {M}_{6} ) + ( {ϕ}_{None} -> {M}_{7} ) + ( ( {ϕ}_{Score} > μ + {σ}_{Score} -> {M}_{9} ) ⊕ ( {ϕ}_{Score} < μ - {σ}_{Score} -> {M}_{10} ) ) ) ]$$

The notations have the same general meaning as in Eq. (1), and the sum is over all homework tasks the student did on subject A. The meaning of the various parameters and values in Eq. (2) are the same as or similar to the corresponding items described for Eq. (1), except that the task now refers to homework task, and that the “retake” modifier M₈ is not used in Eq. (2). Also, all homework tasks are assigned the same weight (e.g. 0.5) which is not present in Eq. (2) but will be included when calculating the overall score later. In one particular example, the various modifier values are the same as described above for Eq. (1) except for the absence of Mg.

Third, page work related data is used to calculate a third sub-score. Generally, this sub-score will be higher (or lower) if the student completed a page of study material in a relatively short (or long) amount of time. The results from all pages of study materials on the subject are accumulated.

In one particular example, for each page of study materials, starting from a base score of 0.5, the sub-score is increased or decreased by 0.1 if the student completed the page faster or slower than 1 standard deviation of other students, respectively.

In one particular example, the algorithm for calculating this sub-score is expressed by the following formula (Eq. (3)):

C₃=Σ[C_{base}+(φₜᵢₘₑ>λ+σₜᵢₘₑ→M₄)⊕(φₜᵢₘₑ<λ−σₜᵢₘₑ→M₅))]

The notations have the same general meaning as in Eq. (1), and the sum is over all page tasks the students performed (e.g. read, viewed, etc.) on subject A. The meaning of the various parameters and values in Eq. (3) are the same as or similar to the corresponding items described for Eq. (1) except that the task now refers to a page task, i.e., reading or viewing a page of material. In one particular example, the time modifiers M₅ and M₄ have the same values as described above for Eq. (1).

Fourth, forum related data is used to calculate a fourth sub-score. Generally, this sub-score will be higher if the student attempted to answer questions on the subject, and/or if her answers are verified or accepted by others; and lower if she asked questions on the subject. The results from all forum questions are accumulated.

In one particular example, starting from a base score of 0.5, the sub-score is increased or decreased as follows:
Asks a question on topic A: −0.1
Attempts to answer question on topic A: +0.1
“verified” or “accepted” answer on topic A: +0.3

In one particular example, the algorithm for calculating this sub-score is expressed by the following formula (Eq. (4)):

C₄=σC_{base}+(φₐₛₖ→M₁₁)+(φ_{answer}→M₁₂)+(φ_{Accepted}→M₁₃)

The notations have the same general meaning as in Eq. (1), and the sum is over all questions that the user asked and answered on the forum on subject A. The meaning of the various parameters and values in Eq. (2) are as below:

C_{base}=Base start point

φₐₛₖ=If the user asked a question on this topic

φ_{answer}=If the user answered a question on this topic

φ_{Accepted}=If the user provided an answer on this topic that is accepted

M₁₁=Asked Question Modifier

M₁₂=Answered Question Modifier

M₁₃=Answer Accepted Modifier

It should be understood that Eqs. (1)-(4) are merely examples; many other events or conditions may be included in calculating the sub-scores.

Eqs. (1)-(3) require the mean or average and standard deviation of various values, including time for completion and test and scores, for all students. These values are calculated before the individual student scores are calculated.

After the sub-scores for test, homework, page work and forum related data are calculated using Eqs. (1)-(4), the values are combined by a weighted sum to calculate an overall academic ability score of the student on subject A, as shown below (Eq. (5)):

$$C = \frac{{C}_{1} + {w}_{2} {C}_{2} + {w}_{3} {C}_{3} + {w}_{4} {C}_{4}}{{\sum }_{i = 0}^{4} {N}_{i} {w}_{i}}$$

where w₀ to w₄ are the weights for quizzes, tests, homework tasks, page work tasks and forum questions, respectively; N₀ to N₄ are the numbers of quizzes, tests, homework tasks, page work tasks and forum questions, respectively, that are summed in Eqs. (1) to (4). As described earlier, the weights for quizzes and tests are absorbed into Eq. (1) (as values M₀ and M₁); they do not appear in Eq. (5). In one implementation, the weights w₀ to w₄ are 0.5, 1, 0.5, 0.25 and 0.25, respectively. Of course, these values are merely examples and any desirable weights can be used.

In one implementation, for convenience, the various modifier values in Eqs. (1) to (4) and the weights in Eq. (5) are designed so that most scores will fall within the range of 0 to 1, and scores outside of this range may be rounded to 0 or 1.

The above process is repeated for other subjects of study for this student, and repeated for all students. The scores are stored in a database.

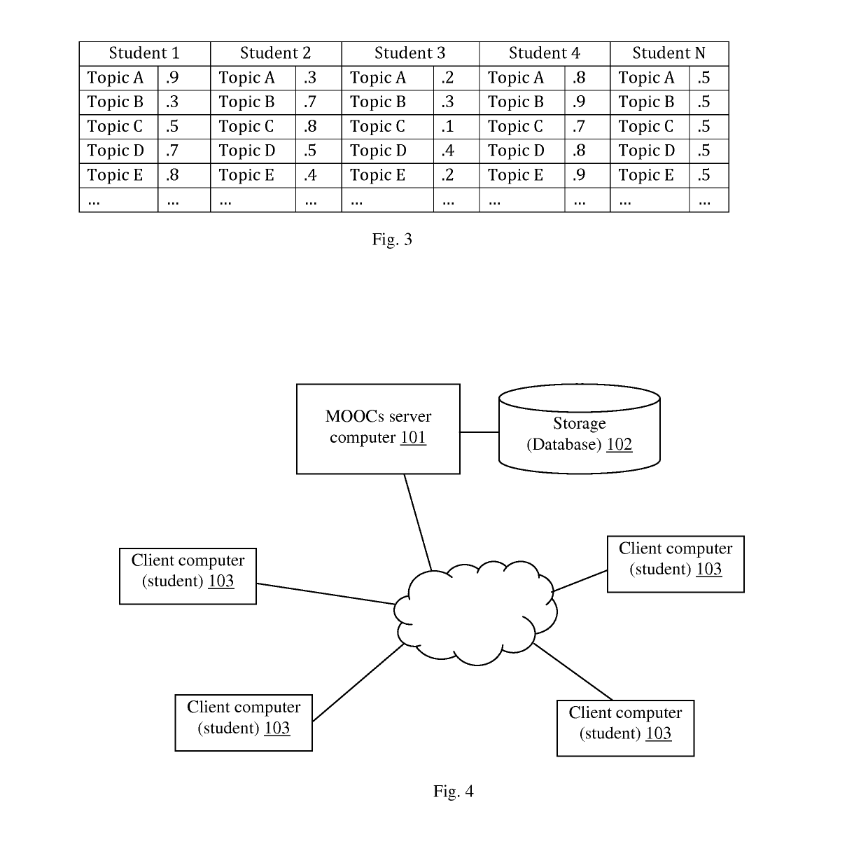

The process of calculating the scores for all students in all subjects, described in detail above, is summarized in FIG. 2. As a result, the score for each student in each of their subjects of study is stored in the database, as schematically illustrated in FIG. 3.

The academic ability scores may be used to rate each student on each topic. For example, in the example of FIG. 3, student 1 is very good in topic A, good in topics D and E, average in topic C and poor in topic B; student 3 is poor or very poor in many topics; and student 4 is good or very good in many topics. Threshold levels may be set to rate each score as good, average and poor. In a particular example, a score of 0.7 or above is deemed good, a score of 0.3 or below is deemed bad, and a score between 0.3 and 0.7 is deemed average. In another example, a student with a score of 0.9 or above in a topic is rated as an expert in that topic, and a student with a score of 0.2 or below in a topic is rated as struggling in that topic.

Either the scores calculated by Eq. (5) or the ratings of each student on each subject may be stored in the database and used in the calculation of peer-review matching scores (step S13 of FIG. 1).

FIG. 4 schematically illustrates a MOOCs system in which the peer-review request assignment method of the embodiments or the present invention may be implemented. The system includes one or more MOOCs servers 101 that provides web-based educational materials, a storage 102 connected to the server storing the student information database, and multiple client computers 103 through which the students accesses the MOOCs server via a network. The server 101 includes processors and memories storing program code that implements the above described methods.

It will be apparent to those skilled in the art that various modification and variations can be made in the peer-review handling method and related apparatus of the present invention without departing from the spirit or scope of the invention. Thus, it is intended that the present invention cover modifications and variations that come within the scope of the appended claims and their equivalents.

What is claimed is:

1. A method implemented in a MOOCs (Massive Open Online Courses) system for handling peer-review of homework assignments, the MOOCs system including one or more server computers providing web-based educational materials, the method being implemented on the server computers, comprising:
(a) storing, in a database, information about each of a plurality of students registered with the MOOCs system, including their academic abilities in each of a plurality of subjects of study;
(b) receiving a peer-review request for reviewing a homework assignment from a requesting student;
(c) selecting as candidate reviewers a group of the plurality of students who are active on the MOOCs system or are predicted to become active within a predetermined time period from a current time;
(d) for each of the candidate reviewers selected in step (c), calculate a peer-review matching score with respect to the homework assignment using the stored academic abilities information of the students;
(e) assigning the peer-review request to a first predetermined number of candidate reviewers who have the highest peer-review matching score among the candidate reviewers; and
(f) upon receiving a second predetermined number of completed reviews from at least some of the reviewers assigned in step (e), each completed review including a grade value for the homework assignment, calculating an average and a standard deviation of the grade values of all completed reviews received up to that time;
(g1) if fewer than a third predetermined number of completed reviews have acceptable grade values based on the calculated standard deviation, repeating steps (c) to (f); and
(g2) if more than or equal to the third predetermined number of completed reviews have acceptable grade values, calculating a final grade for the homework assignment using the completed reviews that have acceptable grade values, and transmitting the final score to the requesting student.

2. The method of claim 1, wherein in step (a), the stored information about each student further include the student's language and peer-review history, and wherein in step (d), the peer-review matching score is calculated further using the stored language and peer-review history information of the students.

3. The method of claim 1,
wherein step (a) further includes storing online access history information of each student, and
wherein in step (c) including predicting students who will become active on the MOOCs system within the predetermined time period using the stored online access history information.

4. The method of claim 1, wherein in step (d), the calculated peer-review matching score is higher if the candidate reviewer speaks a common language as the requesting student, has high academic ability in a subject of the homework assignment, and has peer-reviewed assignments in the subject at a predetermined rate or a higher rate.

5. The method of claim 1, further comprising, before step (a):
gathering academic information about each student regarding each subject including: test related data relating to tests taken by the student, homework related data relating to homework assignments done by the student, page work related data indicating time spent by the student on each page of study materials, and forum related data indicating numbers of forum questions asked or answered by the student;
calculating an academic ability score for each student regarding each subject using the gathered academic information; and
storing the academic ability scores;
wherein the peer-review matching scores in step (d) are calculated using the academic ability scores.

6. A method implemented in a MOOCs (Massive Open Online Courses) system for handling peer-review of homework assignments, the MOOCs system including one or more server computers providing web-based educational materials, the method being implemented on the server computers, comprising:
(a) storing, in a database, information about each of a plurality of students registered with the MOOCs system, including their academic abilities in each of a plurality of subjects of study and their online access histories;
(b) receiving a peer-review request for reviewing a homework assignment from a requesting student;
(c) based on the stored online access history information of the students, selecting as candidate reviewers a group of the plurality of students who are predicted to become active on the MOOCs system within a predetermined time period from a current time;
(d) for each of the candidate reviewers selected in step (c), calculate a peer-review matching score with respect to the homework assignment using the stored academic abilities information of the students;
(e) assigning the peer-review request to a first predetermined number of candidate reviewers who have the highest peer-review matching score among the candidate reviewers; and
(f) calculating a final grade for the homework assignment based on completed reviews received from at least some of the assigned reviewers, and transmitting the final score to the requesting student.

7. The method of claim 6, wherein in step (a), the stored information about each student further include the student's language and peer-review history, and wherein in step (d), the peer-review matching score is calculated further using the stored language and peer-review history information of the students.

8. The method of claim 6, further comprising, after step (e) and before step (f):
(g) upon receiving a second predetermined number of completed reviews from at least some of the reviewers assigned in step (e), each completed review including a grade value for the homework assignment, calculating an average and a standard deviation of the grade values of all completed reviews received up to that time;
(h1) if fewer than a third predetermined number of completed reviews have acceptable grade values based on the calculated standard deviation,
repeating step (c) to select a new group of students who are predicted to become active on the MOOCs system within the predetermined time period from a time when step (c) is repeated,
repeating step (d) to calculate a peer-review matching score for each of the candidate reviewers selected in the repeated step (c),
repeating step (e) to assign the peer-review request based on the peer-review matching scores calculated in the repeated step (d), and
upon receiving the second predetermined number of completed reviews from at least some of the reviewers assigned in the repeated step (e), each completed review including a grade value for the homework assignment, calculating an average and a standard deviation of the grade values of all completed reviews received up to that time; and
(h2) if more than or equal to the third predetermined number of completed reviews have acceptable grade values, performing step (f) to calculate the final grade from the acceptable grade values.

9. The method of claim 6, wherein in step (d), the calculated peer-review matching score is higher if the candidate reviewer speaks a common language as the requesting student, has high academic ability in a subject of the homework assignment, and has peer-reviewed assignments in the subject at a predetermined rate or a higher rate.

10. The method of claim 6, further comprising, before step (a):
gathering academic information about each student regarding each subject including: test related data relating to tests taken by the student, homework related data relating to homework assignments done by the student, page work related data indicating time spent by the student on each page of study materials, and forum related data indicating numbers of forum questions asked or answered by the student;
calculating an academic ability score for each student regarding each subject using the gathered academic information; and
storing the academic ability scores;
wherein the peer-review matching scores in step (d) are calculated using the academic ability scores.

11. A computer program product comprising a computer usable non-transitory medium having a computer readable program code embedded therein for controlling a data processing apparatus, the data processing apparatus forming a MOOCs (Massive Open Online Courses) system including one or more server computers providing web-based educational materials, the computer readable program code configured to cause the data processing apparatus to execute a process for handling peer-review of homework assignments, the process comprising:
(a) storing, in a database, information about each of a plurality of students registered with the MOOCs system, including their academic abilities in each of a plurality of subjects of study;
(b) receiving a peer-review request for reviewing a homework assignment from a requesting student;
(c) selecting as candidate reviewers a group of the plurality of students who are active on the MOOCs system or are predicted to become active within a predetermined time period from a current time;
(d) for each of the candidate reviewers selected in step (c), calculate a peer-review matching score with respect to the homework assignment using the stored academic abilities information of the students;
(e) assigning the peer-review request to a first predetermined number of candidate reviewers who have the highest peer-review matching score among the candidate reviewers; and
(f) upon receiving a second predetermined number of completed reviews from at least some of the reviewers assigned in step (e), each completed review including a grade value for the homework assignment, calculating an average and a standard deviation of the grade values of all completed reviews received up to that time;
(g1) if fewer than a third predetermined number of completed reviews have acceptable grade values based on the calculated standard deviation, repeating steps (c) to (f); and
(g2) if more than or equal to the third predetermined number of completed reviews have acceptable grade values, calculating a final grade for the homework assignment using the completed reviews that have acceptable grade values, and transmitting the final score to the requesting student.

12. The computer program product of claim 11, wherein in step (a), the stored information about each student further include the student's language and peer-review history, and wherein in step (d), the peer-review matching score is calculated further using the stored language and peer-review history information of the students.

13. The computer program product of claim 11,
wherein step (a) further includes storing online access history information of each student, and
wherein in step (c) including predicting students who will become active on the MOOCs system within the predetermined time period using the stored online access history information.

14. The computer program product of claim 11, wherein in step (d), the calculated peer-review matching score is higher if the candidate reviewer speaks a common language as the requesting student, has high academic ability in a subject of the homework assignment, and has peer-reviewed assignments in the subject at a predetermined rate or a higher rate.

15. The computer program product of claim 11, wherein the process further comprises, before step (a):
gathering academic information about each student regarding each subject including: test related data relating to tests taken by the student, homework related data relating to homework assignments done by the student, page work related data indicating time spent by the student on each page of study materials, and forum related data indicating numbers of forum questions asked or answered by the student;
calculating an academic ability score for each student regarding each subject using the gathered academic information; and
storing the academic ability scores;
wherein the peer-review matching scores in step (d) are calculated using the academic ability scores.

16. A computer program product comprising a computer usable non-transitory medium having a computer readable program code embedded therein for controlling a data processing apparatus, the data processing apparatus forming a MOOCs (Massive Open Online Courses) system including one or more server computers providing web-based educational materials, the computer readable program code configured to cause the data processing apparatus to execute a process for handling peer-review of homework assignments, the process comprising:
(a) storing, in a database, information about each of a plurality of students registered with the MOOCs system, including their academic abilities in each of a plurality of subjects of study and their online access histories;
(b) receiving a peer-review request for reviewing a homework assignment from a requesting student;
(c) based on the stored online access history information of the students, selecting as candidate reviewers a group of the plurality of students who are predicted to become active on the MOOCs system within a predetermined time period from a current time;
(d) for each of the candidate reviewers selected in step (c), calculate a peer-review matching score with respect to the homework assignment using the stored academic abilities information of the students;
(e) assigning the peer-review request to a first predetermined number of candidate reviewers who have the highest peer-review matching score among the candidate reviewers; and
(f) calculating a final grade for the homework assignment based on completed reviews received from at least some of the assigned reviewers, and transmitting the final score to the requesting student.

17. The computer program product of claim 16, wherein in step (a), the stored information about each student further include the student's language and peer-review history, and wherein in step (d), the peer-review matching score is calculated further using the stored language and peer-review history information of the students.

18. The computer program product of claim 16, wherein the process further comprises, after step (e) and before step (f):
(g) upon receiving a second predetermined number of completed reviews from at least some of the reviewers assigned in step (e), each completed review including a grade value for the homework assignment, calculating an average and a standard deviation of the grade values of all completed reviews received up to that time;
(h1) if fewer than a third predetermined number of completed reviews have acceptable grade values based on the calculated standard deviation,
repeating step (c) to select a new group of students who are predicted to become active on the MOOCs system within the predetermined time period from a time when step (c) is repeated,
repeating step (d) to calculate a peer-review matching score for each of the candidate reviewers selected in the repeated step (c),
repeating step (e) to assign the peer-review request based on the peer-review matching scores calculated in the repeated step (d), and
upon receiving the second predetermined number of completed reviews from at least some of the reviewers assigned in the repeated step (e), each completed review including a grade value for the homework assignment, calculating an average and a standard deviation of the grade values of all completed reviews received up to that time; and
(h2) if more than or equal to the third predetermined number of completed reviews have acceptable grade values, performing step (f) to calculate the final grade from the acceptable grade values.

19. The computer program product of claim 16, wherein in step (d), the calculated peer-review matching score is higher if the candidate reviewer speaks a common language as the requesting student, has high academic ability in a subject of the homework assignment, and has peer-reviewed assignments in the subject at a predetermined rate or a higher rate.

20. The computer program product of claim 16, wherein the process further comprises, before step (a):
gathering academic information about each student regarding each subject including: test related data relating to tests taken by the student, homework related data relating to homework assignments done by the student, page work related data indicating time spent by the student on each page of study materials, and forum related data indicating numbers of forum questions asked or answered by the student;
calculating an academic ability score for each student regarding each subject using the gathered academic information; and
storing the academic ability scores;
wherein the peer-review matching scores in step (d) are calculated using the academic ability scores.
